(19) United States
(12) Patent Application Publication
(10) Pub. No.: US 2014/0017948 A1
(43) Pub. Date: Jan. 16, 2014

(54) BUTTED CONNECTOR

(71) Applicant: Yazaki Corporation, Tokyo (JP)

(72) Inventors: Terufumi HARA, Makinohara-shi (JP); Masayuki SAITOH, Makinohara-shi (JP)

(73) Assignee: Yazaki Corporation, Tokyo (JP)

(21) Appl. No.: 14/023,512

(22) Filed: Sep. 11, 2013

Related U.S. Application Data
(63) Continuation of application No. PCT/JP2012/057670, filed on Mar. 16, 2012.

(30) Foreign Application Priority Data
Mar. 16, 2011 (JP) 2011-057723

(51) Int. Cl. H01R 13/28

(52) U.S. Cl. CPC H01R 13/28
USPC 439/626

(57) ABSTRACT

When terminal containing holes are slid in a direction, which intersects orthogonally with a direction along the housing central axes, from respective positions in which these holes are displaced in the direction that intersects orthogonally with the direction along the housing central axes, connection of a pair of connector housings is completed, and also top ends of the butted terminals installed into the connector housings respectively are engaged with each other and the top ends are brought into their butted state. Also, when the top ends of the butted terminals are engaged with top ends of the counter butted terminals, the top-end positioning pieces of the butted terminals are engaged with the counter butted terminals respectively, and restrict a disengagement from the counter butted terminals in the axial direction respectively.

### CROSS REFERENCE TO RELATED APPLICATION

This application is a continuation of PCT application No. PCT/JP2012/057670, which was filed on Mar. 16, 2012 based on Japanese Patent Application (No. 2011-057723) filed on Mar. 16, 2011, the contents of which are incorporated herein by reference. Also, all the references cited herein are incorporated as a whole.

### BACKGROUND OF THE INVENTION

1. Field of the Invention

The present invention relates to a butted connector in which butted terminals that are brought into a conduction state to counter terminals respectively when these terminals are butted into the counter terminals are installed in a pair of connector housings that are fitted and connected together.

2. Description of the Related Art

A butted connector is equipped with a pair of connector housings that are fitted and connected together, and butted terminals provided in a pair of these connector housings respectively.

FIG. 34 and FIG. 35 show an example of the butted terminal that is used in the butted connector in the prior art.

A butted terminal 100 shown herein is used in the butted connector disclosed in following JP-T-10-504676, and has a terminal main body 110, a butted plate portion 120, and a spring portion 130.

In the terminal main body 110, a top-end cylindrical portion 111 shaped like a substantially square cylinder, and an electric wire press-fitting portion 112 extended from the rear end of the top-end cylindrical portion 111 are integrally formed of a metal plate by the press working. This terminal main body 110 is inserted into the terminal containing hole of the connector housing (not shown). Then, the terminal main body 110 is engaged with a lance that is made of a resin in the terminal containing hole to prevent its disconnection, and is held in the terminal containing hole.

The butted plate portion 120 is arranged to protrude from the top end of the terminal main body 110, with the purpose of establishing the connection to the counter butted terminal. This butted plate portion 120 corresponds to the part that comes into contact with the top end of the butted terminal in the counter connector housing to establish the electrical connection thereto when the connector housings are fitted and connected mutually.

The spring portion 130 has a corrugated plate structure that supports the butted plate portion 120 in the terminal main body 110 to deform elastically in response to the butting to the counter butted terminal. This spring portion 130 is formed integrally with the butted plate portion 120 by the press working of a metal plate.

The spring portion 130 is fitted into the top-end cylindrical portion 111 such that the butted plate portion 120 is set in a protruded state from the top end of the top-end cylindrical portion 111.

In respective connector housings of the butted connector disclosed in Patent Literature 1, the butted terminal 100 installed into the terminal containing hole is positioned by the latch of the lance in a normal position where the butted plate portion 120 is protruded ahead of the terminal containing hole by a predetermined length.

In the butted connector disclosed in JP-T-10-504676, a pair of connector housings are fitted and connected by the butting operation in a state that respective top end faces are opposed to each other, while aligning respective positions of the terminal containing holes mutually. According to the fitting connection of a pair of connector housings, the butted plate portions 120 of the butted terminals 100 installed into respective connector housings come in contact with each other, and thus the opposing butted terminals 100 are brought into a conductively connected state.

The axial load acting between the butted terminals 100, which are brought into the mutually butted state, is supported by the lance, which is made of a resin and latches the butted terminal 100, and the housing lock portion, which couples the connector housings mutually.

However, in the butted connector disclosed in JP-T-10-504676, the axial load acting between the butted terminals 100, which are caused to butt mutually, is supported by the lances made of a resin, and the housing lock portions that couples the connector housings mutually.

For this reason, when a resin creep is caused in the lances made of a resin and the housing lock portions due to an aged deterioration of resin, or the like, there is possibility in that a contact pressure between the butted terminals 100, 100 would be decreased.

More particularly, as shown in FIG. 36, in the case of the conventional butted terminal 100, such a structure is employed that, when connectors 150, 152 are fitted respectively, lances 140 and the housing lock portions (not shown) accept directly the contact loads of the spring being generated in an arrow W3 direction along the axial direction. As a result, there was a risk that the lances 140 and the housing lock portions, which are subject continuously to the force in the arrow W3 direction, would be deformed due to a resin creep in the arrow W3 direction along which the load is continuously applied.

The butted terminals 100 should be essentially latched and held in the position located at a distance W1 from the butted portion respectively. However, when the resin creep is generated, the butted terminals 100 are latched and held in the position located at a distance W2 from the butted portion respectively. This is because the lances 140 and the housing lock portions are deformed by the resin creep. In this manner, when the latching position is displaced from the distance W1 to the distance W2, a normal amount of displacement cannot be maintained as an amount of displacement of the spring portions of the butted terminals 100. Therefore, there is possibility in that the set contact load could not be secured.

Also, the butted terminals 100, which are already installed into a pair of connector housings, are brought into their butted state merely by the operation that butts a pair of connector housings mutually in the axial direction. Hence, in case foreign substances such as oxide films, dusts, or the like adhere to the surface of the butted plate portion 120 of the butted terminal 100 in the preceding stage of the butting operation, such foreign substances get stuck between the butted plate portions 120, 120, which are put together, by the butting operation. As a result, there is possibility in that the electrical connectivity between the butted terminals would be spoiled due to the intervention of the foreign substances.

### SUMMARY OF THE INVENTION

The present invention has been made in view of these situations and possibilities. It is an object of the present invention to provide a butted connector that is capable of preventing such a situation that a contact pressure between butted terminals that are already butted together is decreased due to a resin creep of lances that latch the butted terminals in a pair of connector housings that are fitted and connected respectively, and the like, also capable of eliminating such a situation that foreign substances get stuck between the butted terminals that are to be butted together and thus mutual conductive connection between the butted terminals is spoiled, and also capable of maintaining mutual connectivity between the butted terminals satisfactorily for a long term.

The above-mentioned object of the present invention can be attained by the configurations (1) to (4) given hereunder.

(1) A butted connector, includes

a butted terminal to a top end of which a butted plate portion that comes into a conductive state to a counter terminal when the butted terminal is brought into contact with the counter terminal is provided; and

a pair of connector housings which have a terminal containing hole into which the butted terminal is inserted, and a lance that latches the butted terminal, which is already inserted into the terminal containing hole, in a normal position where the butted plate portion is set to protrude ahead of the terminal containing hole by a predetermined length, respectively, and which are fitted and connected mutually;

wherein mutual connection of the connector housings is completed when mutual positions of terminal containing holes in the connector housings are aligned with each other by displacing respective positions of the terminal containing holes on mutual top end faces in a direction that intersects orthogonally with the housing central axes, and executing a sliding operation of the pair of connector housings in the direction that intersects orthogonally with the direction along the housing central axes from slide starting positions, in which the connector housings are opposed to each other at a predetermined clearance in a direction along the housing central axes, whereby the sliding operation enables mutual top ends of the butted terminals, which are already installed into respective connector housings, to engage with each other and also enables the mutual top ends of the corresponding butted terminals to bring into their butted state, and

the butted terminal has a top-end positioning piece that is engaged with the counter butted terminal to restrict a disengagement from the counter butted terminal in an axial direction when a top end of the butted terminal is forced to engage with the counter butted terminal.

(2) In the butted connector set forth in (1), the slide starting positions on the pair of connector housings correspond to positions in which the connector housings are displaced in phase around the housing central axes by a predetermined angle respectively in such a condition that the housing central axes of respective connector housings are aligned with each other, and

the sliding operation corresponds to a turning operation executed around the housing central axes respectively.

(3) In the butted connector set forth in (1), the slide starting positions on the pair of connector housings correspond to positions in which the housing central axes of respective connector housings are displaced in the direction that intersects orthogonally with the housing central axes, and

the sliding operation corresponds to a translating operation executed in the direction that intersects orthogonally with the housing central axes.

(4) In the butted connector set forth in any one of (1) to (3), a terminal protection projection, which comes in touch with a counter connector housing when the connector housings are positioned in the slide starting positions respectively and also slides on a butted face of the counter connector housing at a time of sliding operation to restrict a displacement of mutual connector housings in the direction along the housing central axes, is provided to top end portions of the pair of connector housings respectively.

According to the above configuration (1), when a pair of connector housings are slid from the slide starting positions in the direction that intersects orthogonally with the direction along the housing central axes respectively, the mutual fitting connection of the connector housings is completed. Also, the mutual butted connection of the butted terminals executed at the time when the mutual fitting connection of the connector housings is completed is attained by the sliding operation by which the top ends of the butted terminals are engaged with each other. Therefore, a large impact force does not act to the butted terminals in the axial direction respectively. Further, the mutual engagement of the top-end positioning pieces can restrict the disengagement of the mutual butted terminals, which are held in their butted state, from the counter butted terminals in the axial direction, and also can suppress that the axial load would be applied to the lances respectively.

Therefore, it can be suppressed that a resin creep would be generated in the lances, and the like of respective connector housings. Also, it can be prevented that a contact pressure applied between the butted terminals would be decreased by the resin creep of the lances, and the like.

Also, the top ends of the butted terminals are engaged with each other at the time when the butted terminals installed in respective connector housings are caused to butt into each other. Therefore, foreign substances such as oxide films, dusts, or the like, which adhere onto the surfaces of the butted plate portions of the butted terminals, can be scrubbed off in the preceding stage to the butting operation. As a result, such a situation is never caused that the foreign substances adhere between the butted terminals that are to be butted into mutually and thus the mutual conductive connection between the butted terminals is spoiled.

Accordingly, mutual connectivity of the butted terminals can be maintained satisfactorily for a long term.

According to the above configuration (2), not only the mutual connection of the connector housings but also the mutual connection of the butted terminals can be completed, by simply turning the connector housings around the housing central axes respectively after a pair of connector housings are positioned in the slide starting positions. As a result, the operability needed in connecting the butted terminals mutually can be improved.

According to the above configuration (3), not only the mutual connection of the connector housings but also the mutual connection of the butted terminals can be completed, by simply translating respective connector housings in the direction that intersects orthogonally with the housing central axes after a pair of connector housings are placed in the slide starting position respectively. As a result, the operability needed in connecting the butted terminals mutually can be improved.

According to the above configuration (4), when a pair of connector housings are fitted and connected mutually, a clearance between the mutual top end portions of the butted connector housings can be maintained by the terminal protection projections that are provided to the top end portions of the connector housings respectively. As a result, when a protruded length of the terminal protection projections is selected adequately in advance, it can be avoided that an excessive impact force would be applied to the butted terminals at a time of the butting operation, and also it can be prevented that the butted terminals would be deformed by the impact applied in the butting operation.

According to the butted connector of the present invention, the butted connection of the butted terminals at the time when the fitting connection of a pair of connector housings is completed corresponds to the sliding operation by which the top ends of the butted terminals are caused to engage with each other. Therefore, a large impact force does not act to the butted terminals in the axial direction. Further, the mutual engagement of the top-end positioning pieces can restrict the disengagement of the butted terminals, which have already been held in the butted state, from the counter butted terminals in the axial direction, and also can suppress such an event that the axial load is applied to the lances respectively.

As a result, it can be suppressed that a resin creep would be generated in the lances, and the like of respective connector housings. Also, it can be prevented that a contact pressure applied between the butted terminals would be decreased by the resin creep of the lances, and the like.

Also, the top ends of the butted terminals are engaged with each other at the time when the butted terminals installed in respective connector housings are caused to butt into each other. Therefore, the foreign substances such as the oxide films, the dusts, or the like, which adhere onto the surfaces of the butted plate portions of the butted terminals, can be scrubbed off in the preceding stage to the butting operation. As a result, such a situation is never caused that the foreign substances adhere between the butted terminals that are to be butted into mutually and thus the mutual conductive connection between the butted terminals is spoiled.

Accordingly, mutual connectivity of the butted terminals can be maintained satisfactorily for a long term.

### BRIEF DESCRIPTION OF DRAWINGS

FIG. 1 is an exploded perspective view of a first embodiment of a butted connector according to the present invention.

FIG. 2 is a perspective view showing the operations applied at a time of assembling the butted connector according to the present invention.

FIG. 3 is a perspective view of a butted terminal that is installed into a pair of connector housings in the first embodiment.

FIG. 4 is a side view of the butted terminal shown in FIG. 3.

FIG. 5 (a) is a side view showing an intermediate state that a pair of connector housings in the first embodiment are being aligned with a slide starting position mutually, and FIG. 5(b) is an A-A sectional view in FIG. 5(a).

FIG. 6 (a) is a side view showing a state that a pair of connector housings in the first embodiment are aligned with the slide starting position mutually, and FIG. 6(b) is a B-B sectional view in FIG. 6(a).

FIG. 7 (a) is a C-C sectional view of FIG. 6 (a), and FIG. 7 (b) is an enlarged view of a D part in FIG. 7(a).

FIG. 8 is a longitudinal sectional view showing the mutual positional relation of the butted terminals in a state that a pair of connector housings in the first embodiment are aligned with the slide starting position mutually.

FIG. 9 is an enlarged view of an E part in FIG. 8.

FIG. 10 (a) is a side view showing an intermediate state that a pair of connector housings in the first embodiment are being operated to turn around a housing central axis from the slide starting position, and FIG. 10(b) is an F-F sectional view in FIG. 10(a).

FIG. 11 (a) is a G-G sectional view of FIG. 10(a), and FIG. 11 (b) is an enlarged view of an H part in FIG. 11(a).

FIG. 12 is a longitudinal sectional view showing the mutual positional relation of the butted terminals in an intermediate state that a pair of connector housings in the first embodiment are being operated to turn around the housing central axis from the slide starting position mutually.

FIG. 13 is an enlarged view of an I part in FIG. 12.

FIG. 14 (a) is a side view showing a state that the fitting connection between a pair of connector housings in the first embodiment is completed mutually, and FIG. 14 (b) is a J-J sectional view in FIG. 14(a).

FIG. 15 (a) is a K-K sectional view in FIG. 14(a), and FIG. 15 (b) is an enlarged view of an L part in FIG. 15(a).

FIG. 16 is a longitudinal sectional view showing the mutual positional relation of the butted terminals in a state that the fitting connection between a pair of connector housings in the first embodiment is completed mutually.

FIG. 17 is an enlarged view of an M part in FIG. 16.

FIG. 18 is an exploded perspective view of a second embodiment of a butted connector according to the present invention.

FIG. 19 is a perspective view showing a state that the fitting connection between a pair of connector housings is completed in the butted connector shown in FIG. 18.

FIG. 20 (a) is a rear view showing a fitting state while a pair of connector housings in the second embodiment are being operated to slide from the slide starting position in the direction intersected orthogonally with a housing central axis, and FIG. 20(b) is a pertinent cross sectional view showing the mutual positional relation of the butted terminals in the fitted state in FIG. 20(a).

FIG. 21 (a) is a rear view showing a state that the sliding operation of a pair of connector housings in the second embodiment is further advanced from the state in FIG. 20, and FIG. 21 (b) is a pertinent cross sectional view showing the mutual positional relation of the butted terminals in the fitted state in FIG. 21(a).

FIG. 22 (a) is a rear view showing a state immediately before the sliding operation of a pair of connector housings in the second embodiment is completed, and FIG. 22(b) is a pertinent cross sectional view showing the mutual positional relation of the butted terminals in the fitted state in FIG. 22(a).

FIG. 23 is a longitudinal sectional view showing the mutual positional relation of the butted terminals in the fitted state of a pair of connector housings shown in FIG. 22.

FIG. 24 is an enlarged view of an N part in FIG. 23.

FIG. 25 (a) is a rear view showing a state that the fitting connection of a pair of connector housings in the second embodiment is completed, and FIG. 25 (b) is a pertinent cross sectional view showing the mutual positional relation of the butted terminals in the fitting completed state in FIG. 25(a).

FIG. 26 is a longitudinal sectional view showing the mutually butting state of the butted terminals in a state that the fitting connection between a pair of connector housings in the second embodiment is completed.

FIG. 27 is an enlarged view of a P part in FIG. 26.

FIG. 28 is an exploded perspective view of a third embodiment of a butted connector according to the present invention.

FIG. 29 is a perspective view showing one of the connector housings shown in FIG. 28 when viewed from the top end side.

FIG. 30 is a perspective view showing an intermediate state that a pair of connector housings shown in FIG. 28 are being fitted.

FIG. 31 (a) is a side view showing a state that a pair of connector housings in the third embodiment are positioned in the slide starting position, FIG. 31(b) is a longitudinal sectional view showing the mutual positional relation of the butted terminals in the fitted state shown in FIG. 31(a), and FIG. 31 (c) is an enlarged view of a Q part in FIG. 31(b).

FIG. 32 (a) is a side view showing an intermediate state that a pair of connector housings in the third embodiment are being operated to turn around a housing central axis from the slide starting position, FIG. 32 (b) is a longitudinal sectional view showing the mutual positional relation of the butted terminals in the fitted state shown in FIG. 32(a), and FIG. 32 (c) is an enlarged view of an R part in FIG. 32(b).

FIG. 33 (a) is a side view showing a state that the fitting connection of a pair of connector housings in the third embodiment is completed, FIG. 33(b) is a longitudinal sectional view showing the mutual positional relation of the butted terminals in the fitted state shown in FIG. 33(a), and FIG. 33 (c) is an enlarged view of an S part in FIG. 33(b).

FIG. 34 is a longitudinal sectional view showing a butted terminal that is installed into a butted connector in the prior art.

FIG. 35 is a perspective view of the butted terminal shown in FIG. 34.

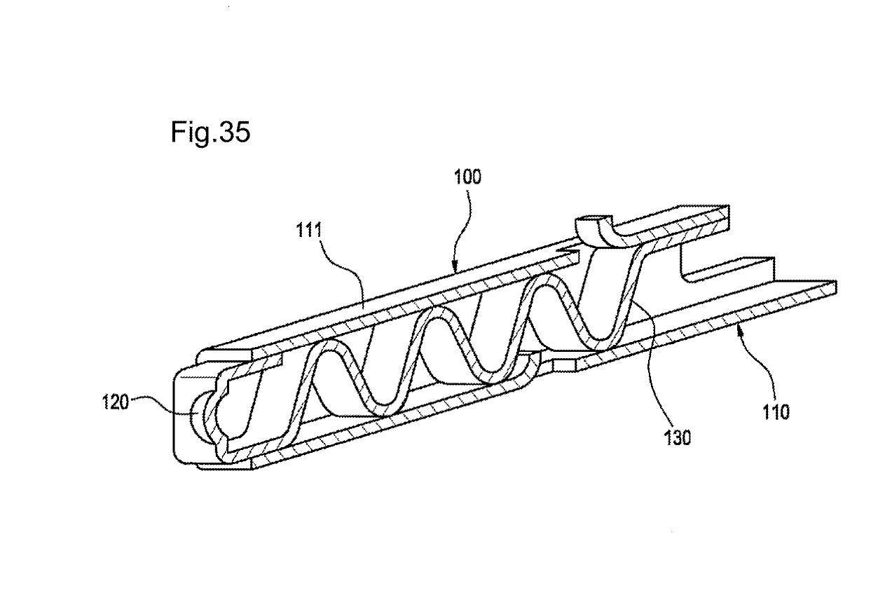

FIG. 36 is a pertinent sectional view of the butted connector in the prior art.

### DESCRIPTION OF THE PREFERRED EMBODIMENTS

Preferred embodiments of a butted connector according to the present invention will be explained in detail with reference to the drawings hereinafter.

### First Embodiment

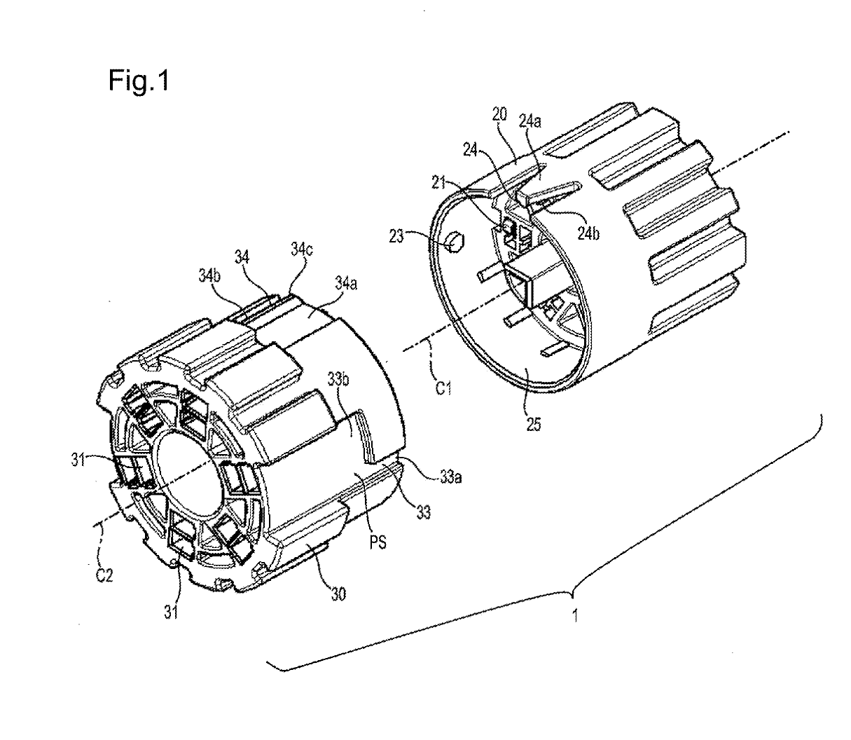

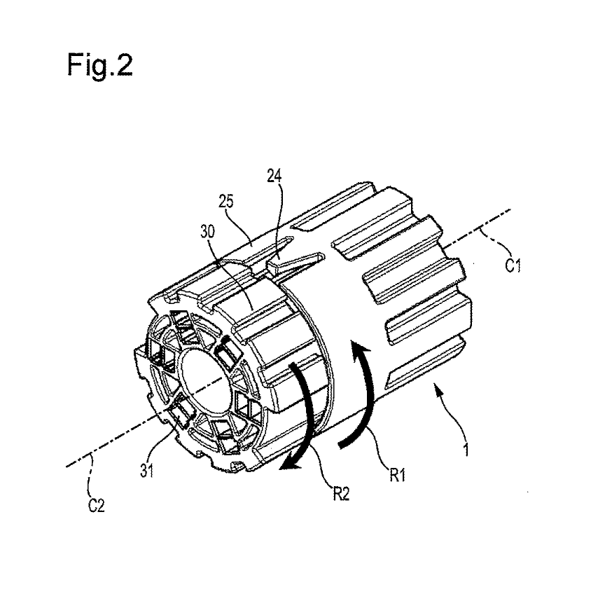

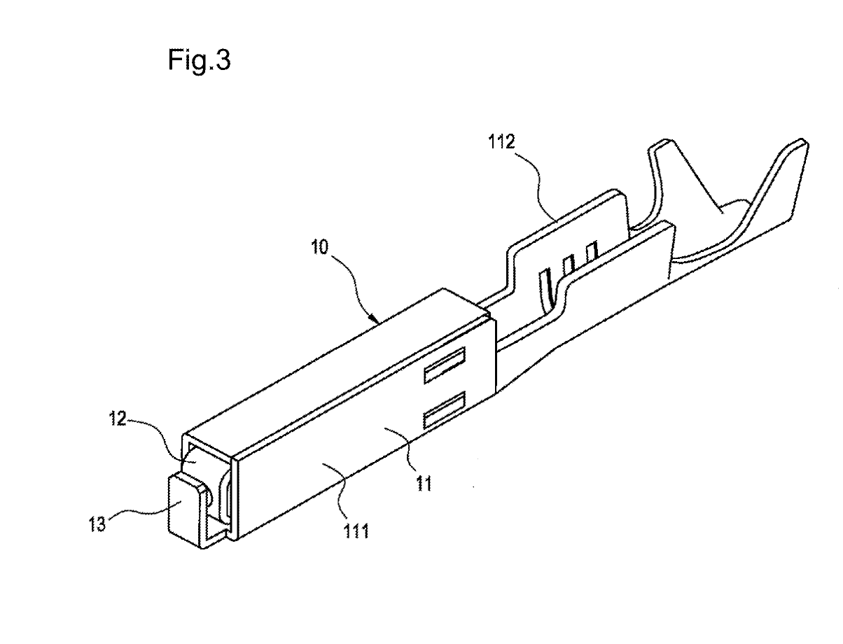

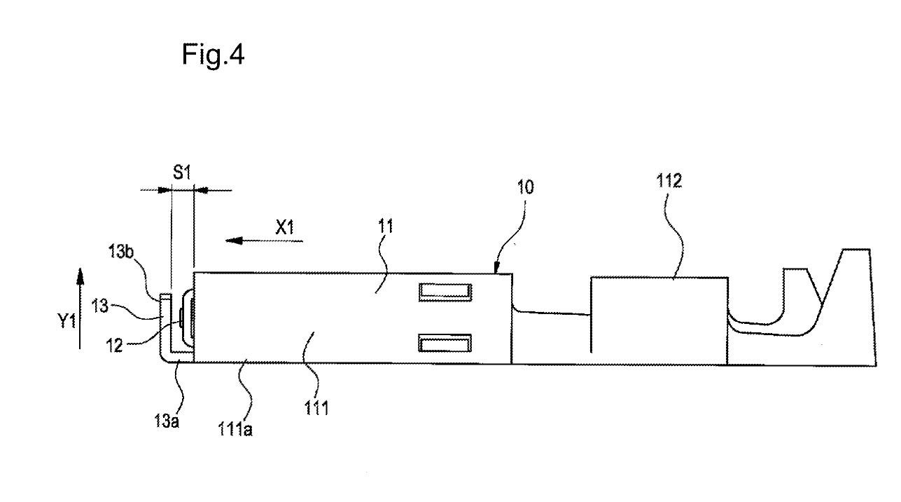

FIG. 1 to FIG. 4 show a configuration of a first embodiment of a butted connector according to the present invention. Here, FIG. 1 is an exploded perspective view of the butted connector in the first embodiment, FIG. 2 is a perspective view showing the operations applied at a time of assembling the butted connector shown in FIG. 1, FIG. 3 is a perspective view of a butted terminal that is installed into a pair of connector housings in the first embodiment, and FIG. 4 is a side view of the butted terminal shown in FIG. 3.

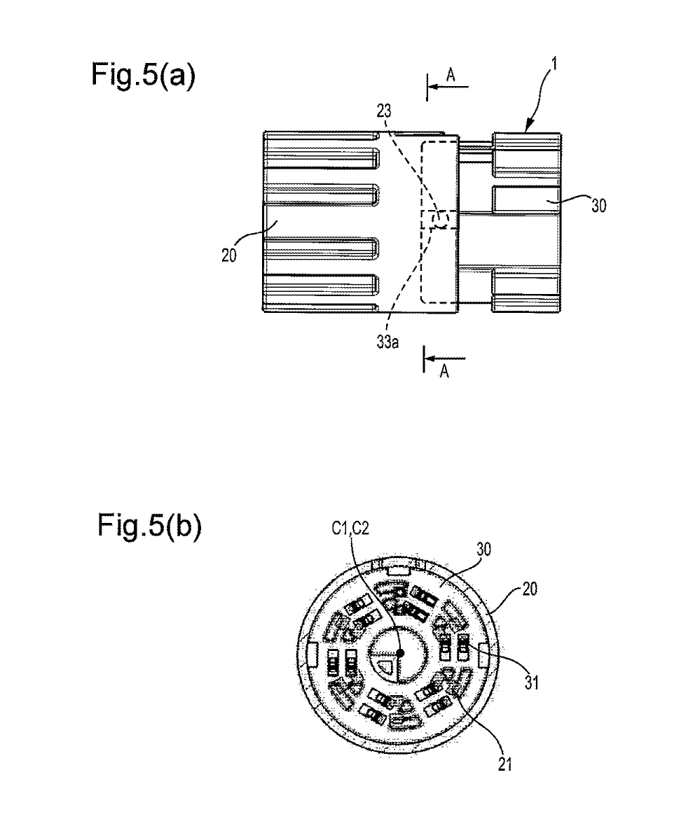

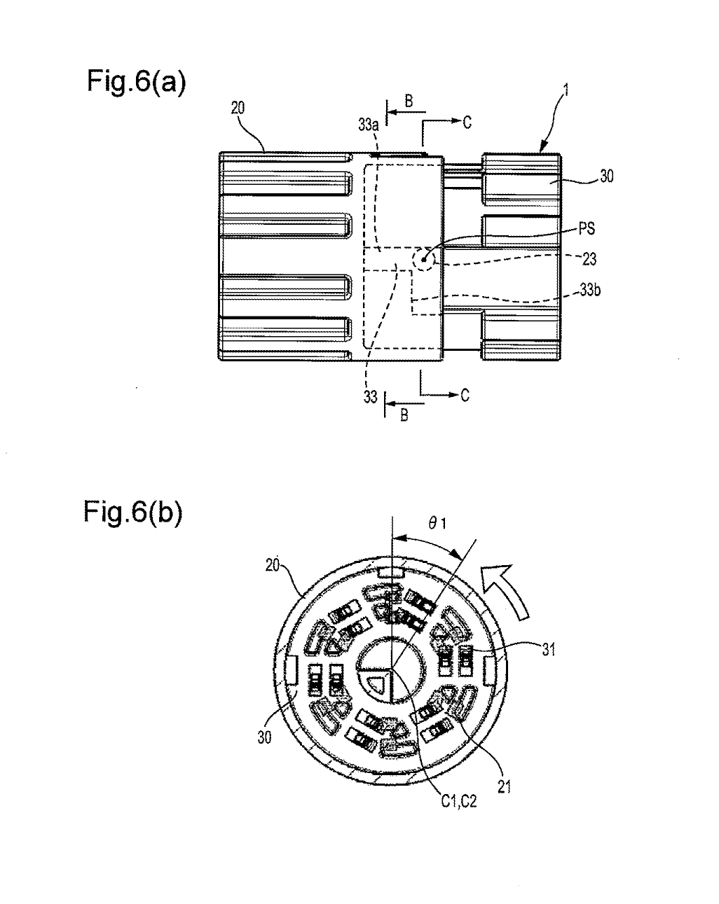

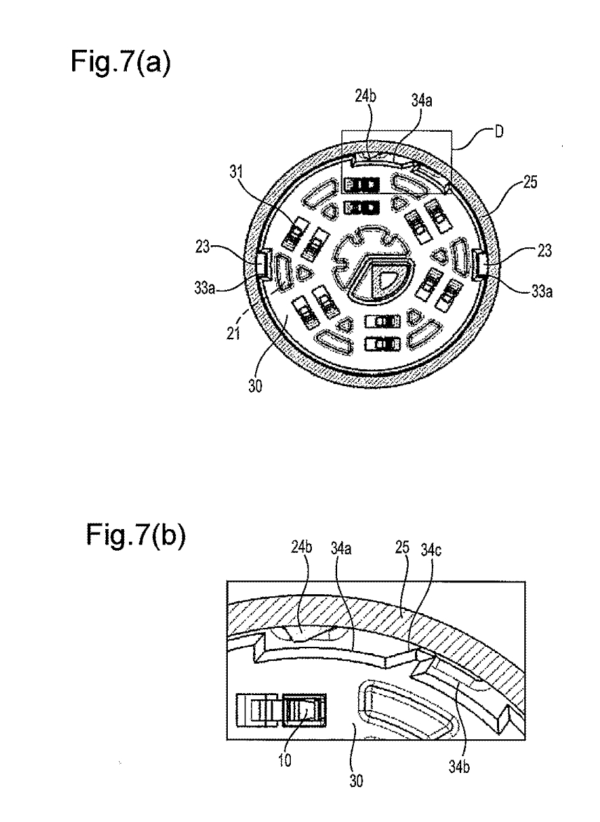

Also, FIG. 5 (a) to FIG. 17 show a state that the housings shown in the first embodiment are connected together by the fitting. Here, FIG. 5(a) is a side view showing an intermediate state that a pair of connector housings in the first embodiment are being aligned with a slide starting position mutually, and FIG. 5(b) is an A-A sectional view in FIG. 5(a), FIG. 6(a) is a side view showing a state that a pair of connector housings in the first embodiment are aligned with the slide starting position mutually, and FIG. 6(b) is a B-B sectional view in FIG. 6(a), and FIG. 7(a) is a C-C sectional view in FIG. 6(a), and FIG. 7(b) is an enlarged view of a D part in FIG. 7(a).

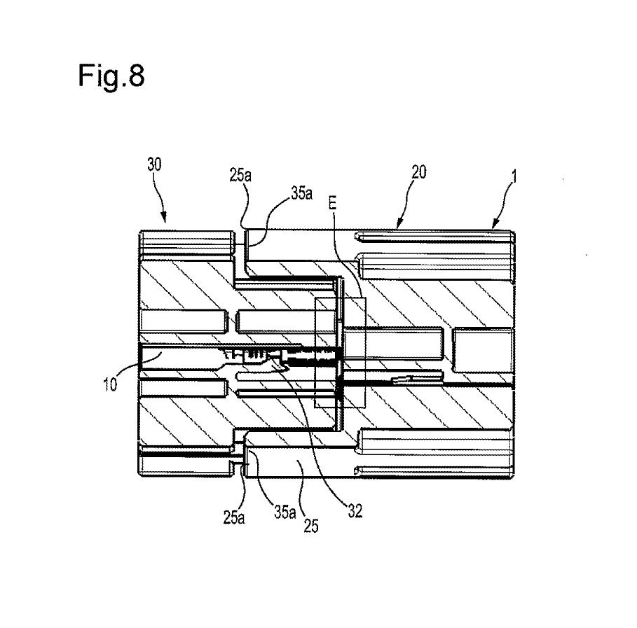

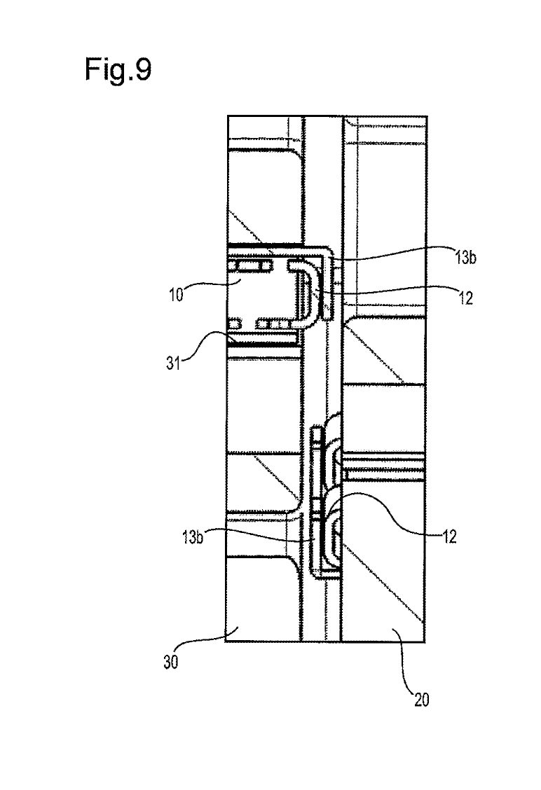

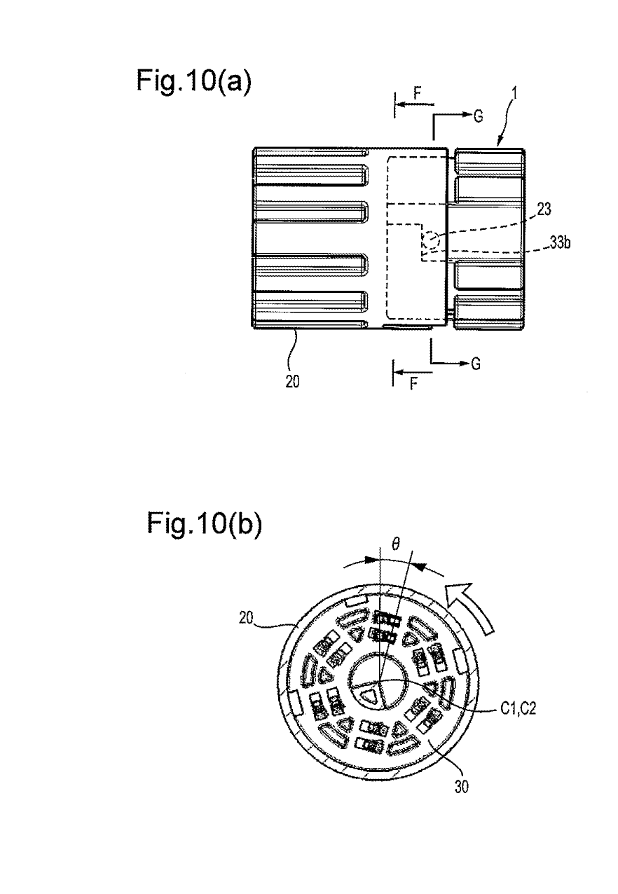

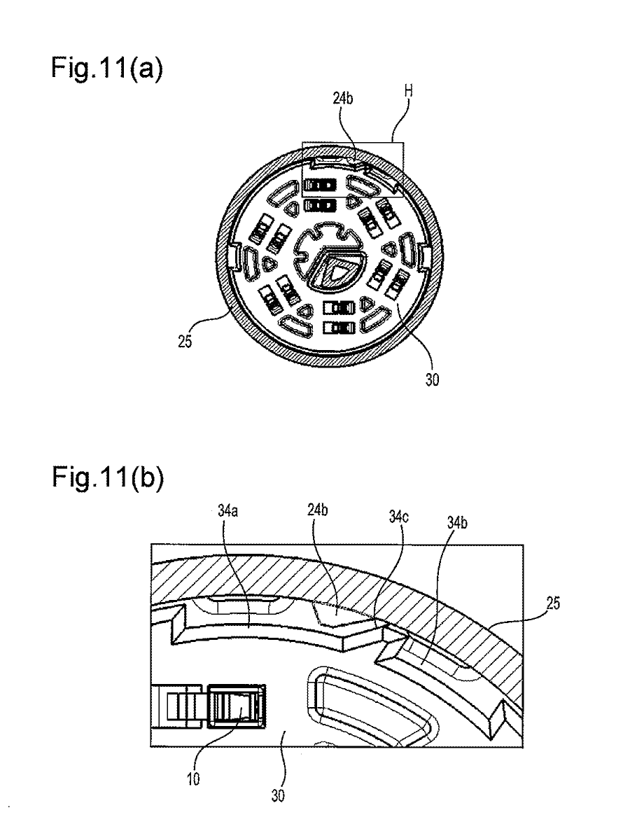

Also, FIG. 8 is a longitudinal sectional view showing the mutual positional relation of the butted terminals in a state that a pair of connector housings in the first embodiment are aligned with the slide starting position mutually, FIG. 9 is an enlarged view of an E part in FIG. 8, FIG. 10(a) is a side view showing an intermediate state that a pair of connector housings in the first embodiment are being operated to turn around a housing central axis from the slide starting position, and FIG. 10(b) is an F-F sectional view in FIG. 10(a), and FIG. 11(a) is a G-G sectional view in FIG. 10(a), and FIG. 11(b) is an enlarged view of an H part in FIG. 11(a).

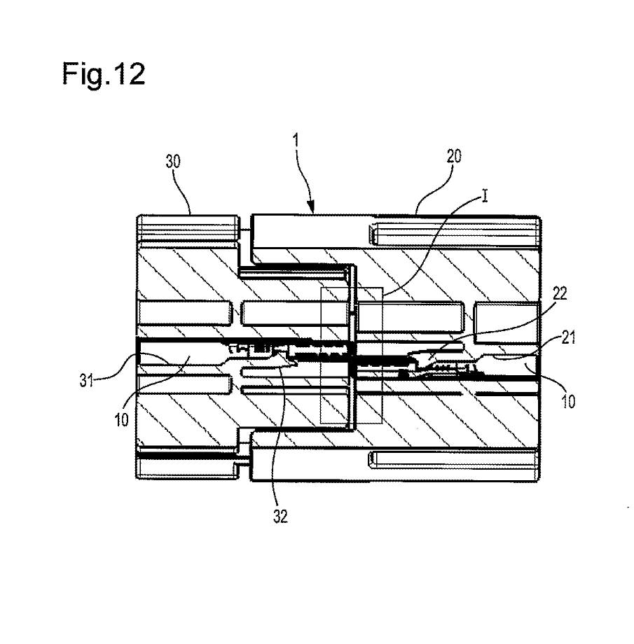

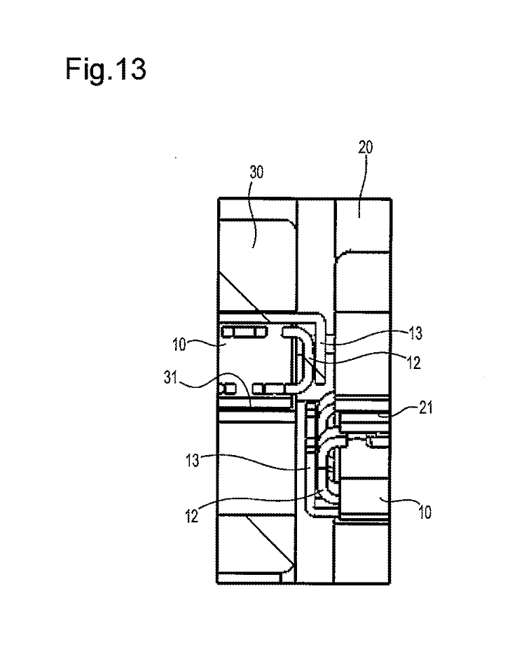

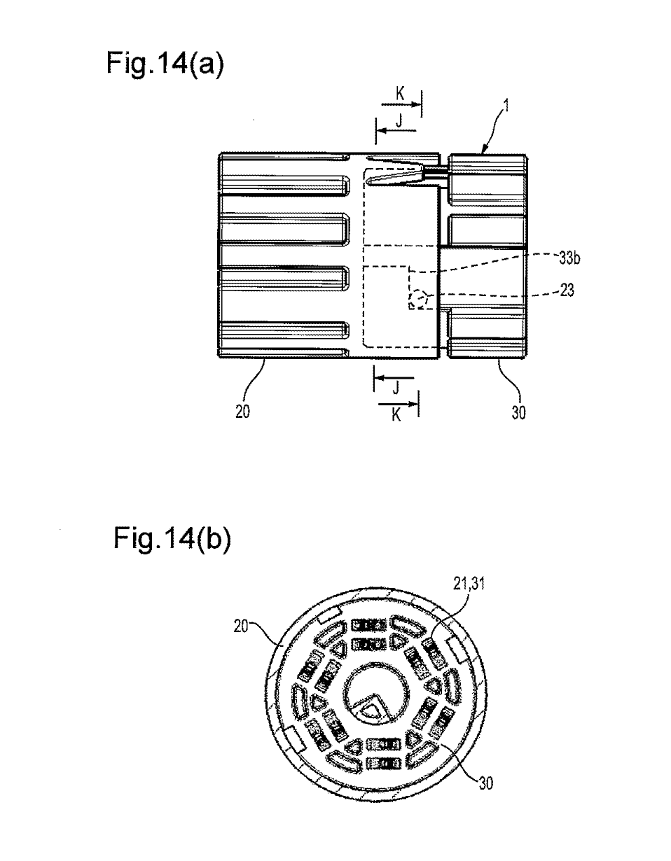

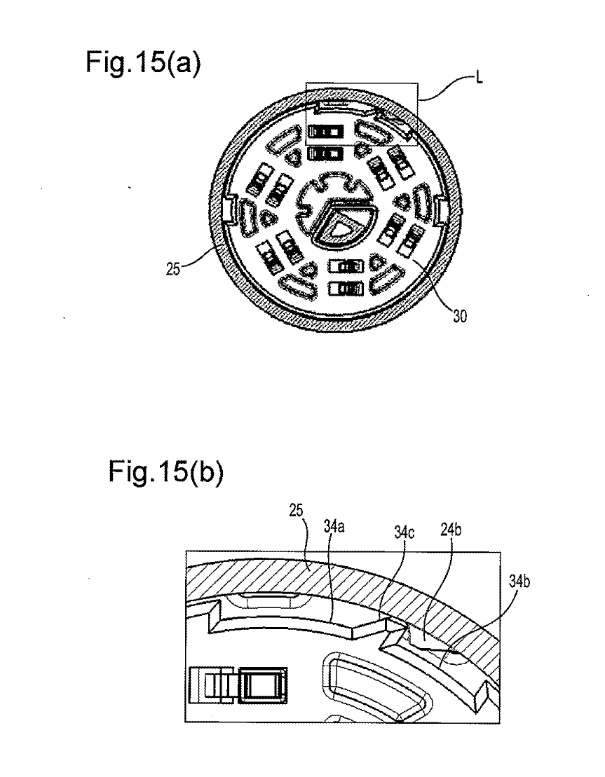

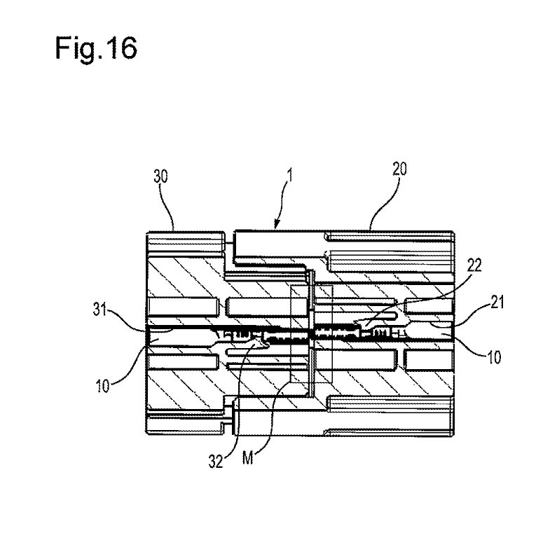

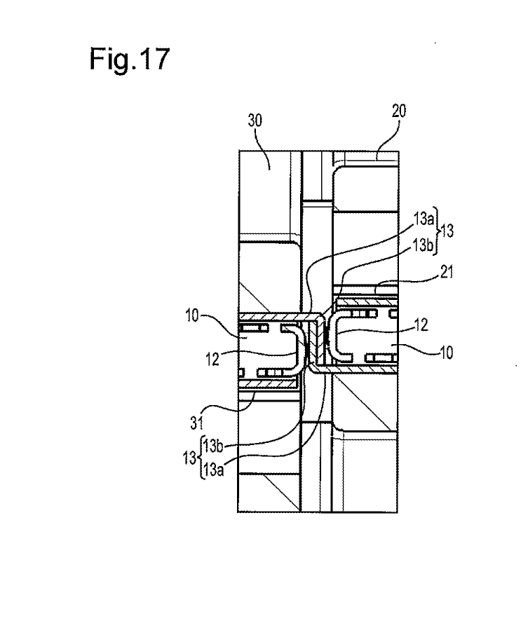

Also, FIG. 12 is a longitudinal sectional view showing the mutual positional relation of the butted terminals in an intermediate state that a pair of connector housings in the first embodiment are being operated to turn around the housing central axis from the slide starting position mutually, FIG. 13 is an enlarged view of an I part in FIG. 12, FIG. 14(a) is a side view showing a state that the fitting connection between a pair of connector housings in the first embodiment is completed mutually, and FIG. 14(b) is a J-J sectional view in FIG. 14(a), FIG. 15(a) is a K-K sectional view in FIG. 14(a), and FIG. 15(b) is an enlarged view of an L part in FIG. 15(a), FIG. 16 is a longitudinal sectional view showing the mutual positional relation of the butted terminals in a state that the fitting connection between a pair of connector housings in the first embodiment is completed mutually, and FIG. 17 is an enlarged view of an M part in FIG. 16.

A butted connector 1 of this first embodiment is constructed by butted terminals 10, and a pair of connector housings 20, 30 in which the butted terminals 10 are installed and held respectively.

As shown in FIG. 3 and FIG. 4, each of the butted terminals 10 has a terminal main body 11, a butted plate portion 12, and a top-end positioning piece 13.

In the terminal main body 11, the top-end cylindrical portion 111 shaped like a substantially square cylinder, and the electric wire press-fitting portion 112 extended from the rear end of the top-end cylindrical portion 111 are integrally formed of a metal plate by the press working. The terminal main bodies 11 are inserted into terminal containing holes 21, 31 of the connector housings 20, 30 respectively. The terminal main bodies 11 inserted in the terminal containing holes 21, 31 are engaged with lances 22, 32 respectively to prevent their disconnection, and are held in the terminal containing holes 21, 31 respectively.

The butted plate portion 12 is fitted to protrude from the top end of the top-end cylindrical portion 111 of the terminal main body 11. The butted plate portion 12 comes into a conductive state to the counter butted terminal when this butted plate portion 12 is brought into contact with the counter butted terminal. This butted plate portion 12 is supported in the terminal main body 11 via spring portions (not shown) that are formed integrally with the butted plate portion 12. The spring portions (not shown) serve to support the butted plate portion 12 in the terminal main body 11, and constitute wavelike springs that are extended from the butted plate portion 12. Both rear end portions of the spring portions are latched in the terminal main body 11, and the spring portions support the butted plate portion 12 to elastically displace along the butting direction.

The top-end positioning piece 13 is formed as a tongue-like piece that is provided to extend upward from the top end of a bottom wall portion 111a of the top-end cylindrical portion 111. This top-end positioning piece 13 has an extended plate portion 13a, and a positioning piece portion 13b. This extended plate portion 13a is extended ahead from the top end of the bottom wall portion 111a in the butting direction of the mutual terminals (an arrow X1 direction in FIG. 4). This positioning piece portion 13b stands up from the top end of this extended plate portion 13a in the perpendicularly upward direction that intersects orthogonally with the butting direction (an arrow Y1 direction in FIG. 4).

As shown in FIG. 4, a clearance S1 is formed between the positioning piece portion 13b of the top-end positioning piece 13 and the butted plate portion 12 located at the top end of the top-end cylindrical portion 111. Here, in FIG. 4, the butted plate portion 12 is held in a state that the butted plate portion 12 has a clearance to the positioning piece portion 13b. Normally, as shown in FIG. 9, an energizing force given by the spring portions (not shown) is acting to the butted plate portion 12 to maintain such a state that the butted plate portion 12 contacts the positioning piece portion 13b.

In other words, the positioning piece portion 13b restricts the movement of the butted plate portion 12, which is installed into the top-end cylindrical portion 111, toward the top end side (the arrow X1 side in FIG. 4) (the movement of the butted plate portion 12 caused by the energizing force of the spring portion (not shown)). Further, as shown in FIG. 17 described later, when the positioning piece portions 13b of the counter butted terminals 10 are forced by the mutual turning operation of the connector housings, described later, to cut into places between the positioning piece portions 13b and the butted plate portions 12 respectively, the positioning piece portions 13b of the butted terminals 10 are brought into an engaged state with the positioning piece portions 13b of the counter butted terminals 10. Therefore, the positioning piece portions 13b restrict the disengagement of the butted terminals 10 from the counter butted terminals 10 in the axial direction.

To explain in more detail, when the positioning piece portions 13b of the counter butted terminal 10 are forced by the mutual turning operations of the connector housings, described later, to break into places between the positioning piece portions 13b and the butted plate portions 12 of the own butted terminals 10, the positioning piece portions 13b and the butted plate portions 12 of the mutual butted terminals 10 are engaged with each other respectively. As a result, the top ends of the corresponding butted terminals 10 are brought into their butted states (connected states) mutually.

A pair of connector housings 20, 30 are equipped with the terminal containing holes 21, 31 into which the butted terminal 10 is inserted respectively, the lances 22, 32 (see FIG. 12), guide protrusions 23 and guide grooves 33 constituting the guiding mechanism respectively, and a lock arm 24 and a lock groove 34 constituting the locking mechanism, respectively.

The connector housing 20 corresponds to the so-called female housing. As shown in FIG. 1, this connector housing 20 has a cylindrical hood portion 25 on the top end side. This hood portion 25 is fitted turnably on an outer periphery of the connector housing 30 as the male housing on the front-end side.

The terminal containing holes 21, 31 are arranged in plural at a predetermined interval on the circumferences of the connector housings 20, 30 around respective housing central axes C1, C2.

As shown in FIG. 12 and FIG. 13, the lances 22, 32 provided to respective connector housings 20, 30 latch the butted terminals 10, which are inserted into the terminal containing holes 21, 31 of respective connector housings 20, 30, in their normal positions respectively. In the normal positions, the top-end positioning pieces 13 and the butted plate portions 12 are set to protrude ahead of the terminal containing holes 21, 31 by a predetermined length respectively.

As shown in FIG. 1, the guide protrusions 23 constituting the guiding mechanism correspond to columnar projections that are provided on an inner periphery of the hood portion 25 of the connector housing 20 to protrude inwardly. As shown in FIG. 7, the guide protrusion 23 is provided in two opposing positions on the inner periphery of the hood portion 25.

The guide grooves 33 constituting the guiding mechanism correspond to the recesses that are formed on the outer circumference of the connector housing 30. The guide grooves 33 guide the guide protrusion 23 respectively when the connector housings 20, 30 are fitted and connected, and thus restrict the mutual fitting motion of the connector housings 20, 30.

As shown in FIG. 1, each of the guide grooves 33 is constructed by an axial direction groove 33a and a circumferential direction groove 33b. The axial direction groove 33 is provided to extend along the housing central axis C2. The circumferential direction groove 33b is formed to extend from the rear end of the axial direction groove 33a in the circumferential direction.

The axial direction grooves 33a are formed from the top end side of the connector housing 30 by a predetermined length along the housing central axis C2. These axial direction grooves 33a restrict the movement of the fitted guide protrusion 23 along the direction of the housing central axis C2 respectively. As shown in FIG. 7, the axial direction groove 33a is provided to the outer periphery of the connector housing 30 in two opposing positions that correspond to the arrangement of the guide protrusions 23 in the hood portion 25. The rear ends of the axial direction grooves 33a serve as slide starting positions PS from which relatively turning operations between both connector housings 20, 30 in a circumferential direction are started. When the guide protrusions 23 reach the slide starting positions PS respectively, a top end 25a of the hood portion 25 comes into contact with a stepped portion 35a formed on the outer periphery of the connector housing 30, as shown in FIG. 8. Thus, such an event can be restricted that the mutual fitting of the housings in the axial direction becomes deeper.

Also, when the guide protrusions 23 reach the slide starting positions PS respectively, respective positions of the top end portions of the connector housings in the axial direction are positioned in the positions that oppose to each other at a predetermined clearance in the direction of the housing central axes C1, C2, as shown in FIG. 9, such that the positioning piece portions 13b of the butted terminals 10 being installed in the connector housing 20 are positioned on the inner side of the positioning piece portions 13b of the butted terminals 10 being installed in the connector housing 30 respectively.

When the guide protrusions 23 are moved on the axial direction grooves 33a respectively and when the guide protrusions 23 reach the slide starting positions PS respectively, the terminal containing holes 21, 31 provided in respective connector housings are arranged in their positions where these holes are displaced in the circumferential direction that intersects orthogonally with the housing central axes C1, C2, as shown in FIG. 5 (a) to FIG. 6(b). At this time, an amount of displacement between the terminal containing holes 21, 31 in the circumferential direction is indicated with an angle 81 shown in FIG. 6(b).

In other words, in the case of the present embodiment, the slide starting positions PS set on a pair of connector housings 20, 30 correspond to the positions where their phases are shifted only by an angle θ1 around the housing central axes C1, C2 in such a condition that the housing central axes C1, C2 of respective connector housings are aligned with each other.

As shown in FIG. 2, the circumferential direction grooves 33b allow the guide protrusion 23 to move in the circumferential direction respectively when the connector housings 20, 30 positioned in the slide starting positions PS respectively are relatively turned in the opposite directions mutually, as indicated with arrows R1, R2 respectively.

As explained above, the guiding mechanisms each constructed by the guide protrusion 23 and the guide groove 33 are provided. Therefore, when a pair of connector housings 20, 30 are operated to slide (turn) from the slide starting positions PS in the circumferential direction, which intersects orthogonally with the direction of the housing central axes C1, C2, respectively in such a manner that the mutual positions of the terminal containing holes 21, 31 are aligned with each other, the mutual connection of the connector housings can be completed.

Also, as shown in FIGS. 14(a) and 14(b), when the mutual positions of the terminal containing holes 21, 31 are aligned with each other by the turning operation of the connector housings from the slide starting positions PS to coincide with each other, the top ends of the butted terminals 10 that are already installed into respective connector housings are engaged with each other. Thus, the top ends of the corresponding butted terminals 10 are brought into the butted state mutually.

Further, to explain in detail, as shown in FIG. 17, the positioning piece portions 13b of the top-end positioning pieces 13 cut into places between the positioning piece portions 13b and the butted plate portions 12 of the counter butted terminals 10 respectively at the time when the top ends of the butted terminals 10 are engaged with the top ends of the counter butted terminals 10 respectively. According to this cutting-in operation, respective top end portions of the butted terminals 10 can be engaged with each other, so that the disengagement of the butted terminal 10 from the counter butted terminal 10 in the axial direction can be restricted.

As shown in FIG. 1, the lock arm 24 constituting the locking mechanism is provided onto the hood portion 25 of the connector housing 20. As shown in FIG. 1, this lock arm 24 has an arm portion 24a formed by cutting off a part of the circumferential wall of the hood portion 25 from the surrounding area like an arm shape, and an engaging projection 24b formed on the free end side of the arm portion 24a to rise toward the inner diameter side.

As shown in FIG. 1, the lock groove 34 constituting the locking mechanism is provided onto the outer periphery of the connector housing 30 to engage with the lock arm 24. As shown in FIG. 1, this lock groove 34 has a guiding groove portion 34a, an engaging groove 34b provided to the rear end of the guiding groove portion 34a in the circumferential direction, and a raised crisping portion 34c for partitioning the lock groove 34 into the guiding groove portion 34a and the engaging groove 34b.

The guiding groove portion 34a corresponds to the recess that allows the engaging projection 24b to move therein at the time when the guide protrusion 23 is moved on the guide groove 33 up to the slide starting position PS and when the guide protrusions 23 are moved from the slide starting positions PS along the circumferential direction grooves 33b respectively.

The engaging groove 34b corresponds to the recess that engages with the engaging projection 24b to restrict the movement of the engaging projection 24b in the circumferential direction at the time when the guide protrusions 23 reach the rear ends of the circumferential direction grooves 33b respectively and thus the positions of the terminal containing holes 21, 31 of the mutual housings are aligned with each other.

The raised crisping portion 34c corresponds to the raised portion that the engaging projection 24b gets over before the engaging projection 24b is engaged with the engaging groove 34b. This raised crisping portion 34c gives a crisp feel to the worker based on a resistance force that is produced when the engaging projection 24b gets over the raised crisping portion 34c. This sense of touch of the raised crisping portion 34c makes the worker aware of that the connection of the connector housings 20, 30 is going to complete.

Next, a series of operations applied when the connector housings 20, 30 are fitted and connected mutually in the butted connector 1 explained above will be explained based on the drawings hereunder.

First, as shown in FIG. 1, the housing central axes C1, C2 of the connector housings 20, 30 are set to align with each other, and also the positions of the guide protrusions 23 on the connector housing 20 are set to coincide with the positions of the axial direction grooves 33a on the connector housing 30 respectively. Thus, the connector housing 20 and the connector housing 30 are positioned to oppose to each other.

Then, as shown in FIGS. 5(a) and 5(b), the connector housings 20, 30 are fitted mutually, and then the guide protrusions 23 are pushed forward along the axial direction grooves 33a. At this time, as shown in FIG. 5(b), the terminal containing holes 21 in the connector housing 20 and the terminal containing hole 31 in the connector housing 30 are arranged to displace in the circumferential direction.

Then, when the fitting of the connector housing 20 and the connector housing 30 in the axial direction is further deepened, the guide protrusions 23 reach the slide starting positions PS, as shown in FIG. 6. When the guide protrusions 23 reach the slide starting positions PS, the engaging projection 24b of the lock arm 24 is positioned in the guiding groove portion 34a of the lock groove 34, as shown in FIG. 7. Also, when the guide protrusions 23 reach the slide starting positions PS, the butted terminals 10 as the butted objects in the connector housings 20, 30 are positioned mutually in the axial positions where the positioning piece portions 13b of one butted terminals 10 are allowed to enter into respective inner sides of the positioning piece portions 13b of the other butted terminals 10, as shown in FIG. 8 and FIG. 9.

Then, as shown in FIGS. 10(a) and 10(b), the connector housing 20 and the connector housing 30 are operated to turn mutually such that the guide protrusions 23 are moved in the circumferential direction grooves 33b from the slide starting positions PS in the circumferential direction. As the guide protrusions 23 come closer to the rear ends of the circumferential direction grooves 33b, a difference angle θ in phase between the terminal containing holes 21, 31 of the mutual housings is narrowed, as shown in FIG. 10(b). Also, as shown in FIGS. 11(a) and 11(b), the engaging projection 24b of the lock arm 24 is moved in the guiding groove portion 34a of the lock groove 34 toward the raised crisping portion 34c. Also, as shown in FIG. 12 and FIG. 13, the displacement between respective butted terminals 10 as the butted objects in the circumferential direction in the connector housings 20, 30 is gradually reduced.

The relative turning operations of the connector housings 20, proceed furthermore. Then, as shown in FIG. 14(a), the guide protrusions 23 reach the rear ends of the circumferential direction grooves 33b. At that time, as shown in FIG. 14(b), the positions of the terminal containing holes 21, 31 of the mutual housings are aligned with each other respectively, and thus the fitting connection of the mutual connector housings is brought into its completed state. Also, at this time, as shown in FIGS. 15(a) and 15(b), the engaging projection 24b of the lock arm 24 goes over the raised crisping portion 34c and engages with the engaging groove 34b. Thus, the mutual connector housings are put in their locked state in which the movement of the mutual connector housings in the circumferential direction is restricted. Also, at this time, as shown in FIG. 16 and FIG. 17, the butted terminals 10 as the butted objects in the connector housings 20, 30 are engaged with each other respectively such that the positioning piece portions 13b of one butted terminals 10 are forced to cut into places between the positioning piece portions 13b and the butted plate portions 12 of the other butted terminals 10. Accordingly, the butted plate portions 12 of the butted terminals 10 come in their butted states to the top-end positioning pieces 13 of the counter butted terminals 10 respectively, and as a result the mutual butted connection of the butted terminals 10 is completed.

In the case of the butted connector 1 of the first embodiment explained above, the mutual fitting connection of the connector housings can be completed by operating a pair of connector housings 20, 30 to turn (slide) in the circumferential direction, which intersects orthogonally with the directions along the housing central axes C1, C2 from the slide starting positions PS.

Then, the mutual butting connection of the butted terminals 10 needed at the time when the mutual fitting connection of the connector housings is completed can be carried out by the sliding operation by which the top ends of the butted terminals 10 are engaged with each other. Therefore, a large impact force does not act to the respective butted terminals 10 in the axial direction. Further, the mutual engagement of the top-end positioning pieces 13 can restrict the disengagement of the butted terminals 10, which have already been held in the butted state mutually, from the counter butted terminals 10 in the axial direction, and also can suppress such an event that the axial load acts to the lances 22, 32 respectively.

As a result, it can be suppressed that a resin creep would be generated in the lances 22, 32, and the like of respective connector housings. Also, it can be prevented that a contact pressure between the butted terminals 10 would be decreased by the resin creep of the lances 22, 32, and the like.

Also, the top ends of the butted terminals 10 are engaged with each other at the time when the butted terminals 10 installed in respective connector housings are caused to butt into each other. Therefore, the foreign substances such as the oxide films, the dusts, or the like, which adhere onto the surfaces of the butted plate portions 12 of the butted terminals 10, can be scrubbed off in the preceding stage to the butting operation. As a result, such a situation is never caused that the foreign substances adhere between the butted terminals 10 that are to be butted into mutually and thus the mutual conductive connection between the butted terminals 10 is spoiled.

Accordingly, mutual connectivity of the butted terminals 10 can be maintained satisfactorily for a long term.

Also, in the case of the butted connector 1 in the present embodiment, not only the mutual connection of the connector housings but also the mutual connection of the butted terminals 10 can be completed, by simply turning the connector housings around the housing central axes C1, C2 respectively after a pair of connector housings 20, 30 are placed in the slide starting position PS respectively. As a result, the operability needed in connecting mutually the butted terminals 10 can be improved.

### Second Embodiment

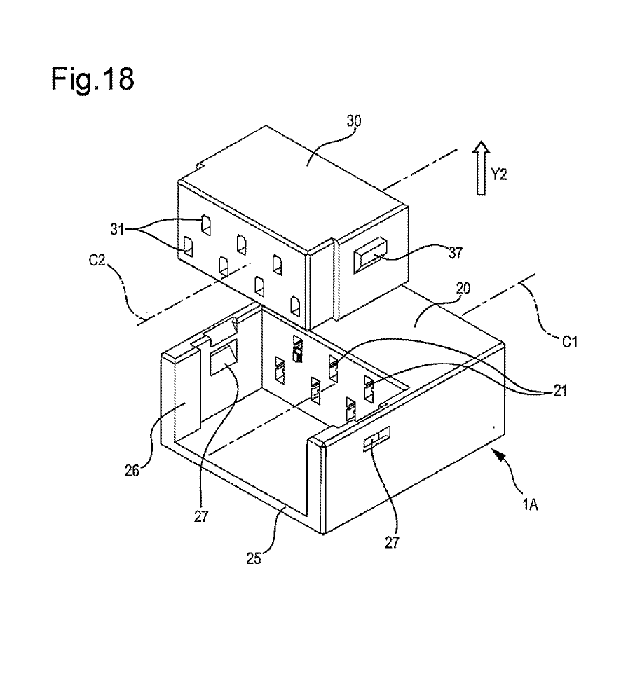

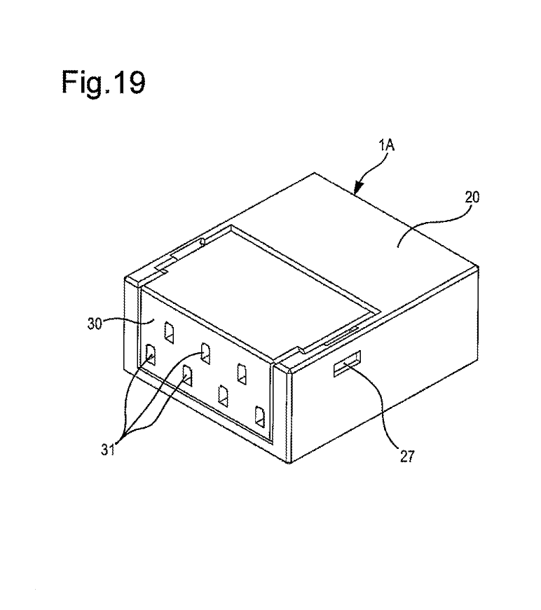

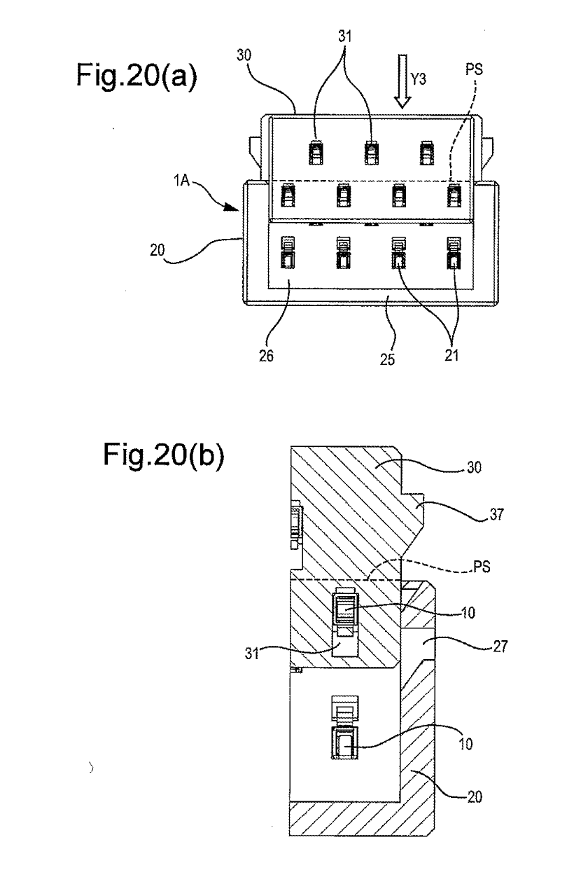

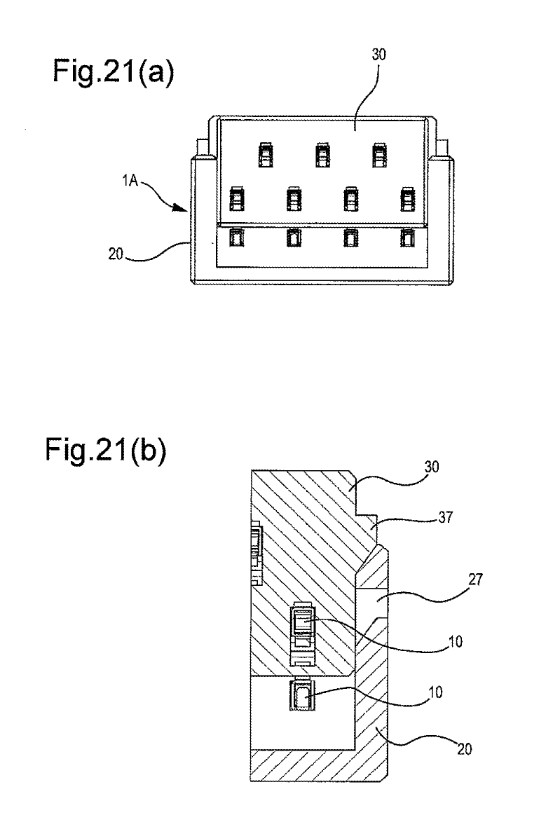

FIG. 18 to FIG. 27 show a configuration of a second embodiment of a butted connector according to the present invention. Here, FIG. 18 is an exploded perspective view of the butted connector in the second embodiment, FIG. 19 is a perspective view showing a state that the fitting connection between a pair of connector housings is completed in the butted connector shown in FIG. 18, FIG. 20(a) is a rear view showing a fitting state while a pair of connector housings in the second embodiment are being operated to slide from the slide starting position in the direction intersected orthogonally with a housing central axis, and FIG. 20(b) is a pertinent cross sectional view showing the mutual positional relation of the butted terminals in the fitted state in FIG. 20(a), and FIG. 21(a) is a rear view showing a state that the sliding operation of a pair of connector housings in the second embodiment is further advanced from the state in FIG. 20, and FIG. 21(b) is a pertinent cross sectional view showing the mutual positional relation of the butted terminals in the fitted state in FIG. 21(a).

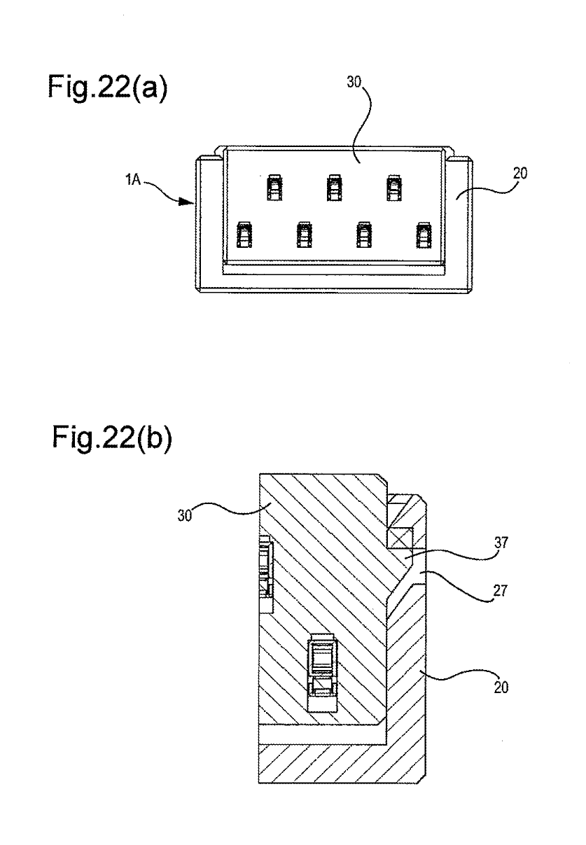

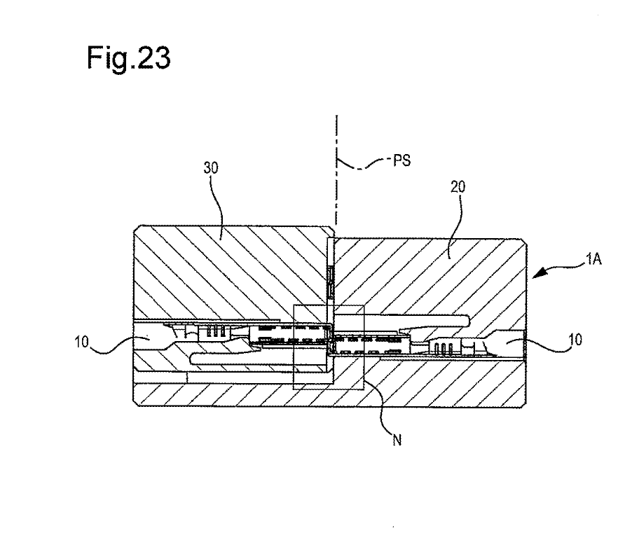

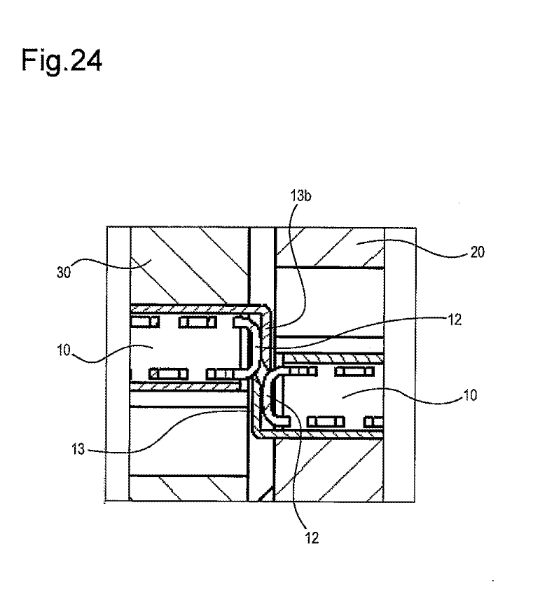

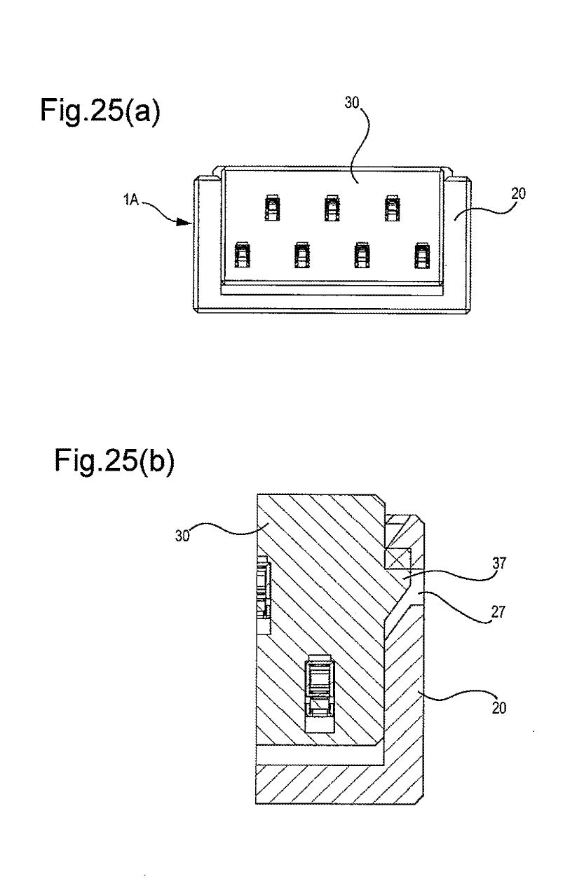

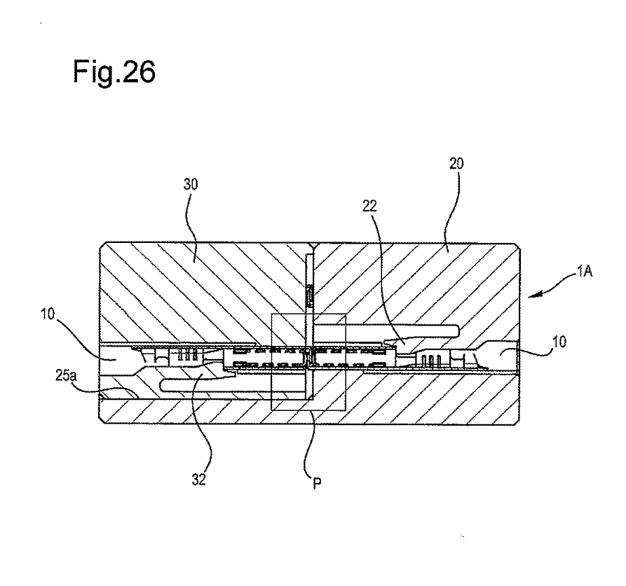

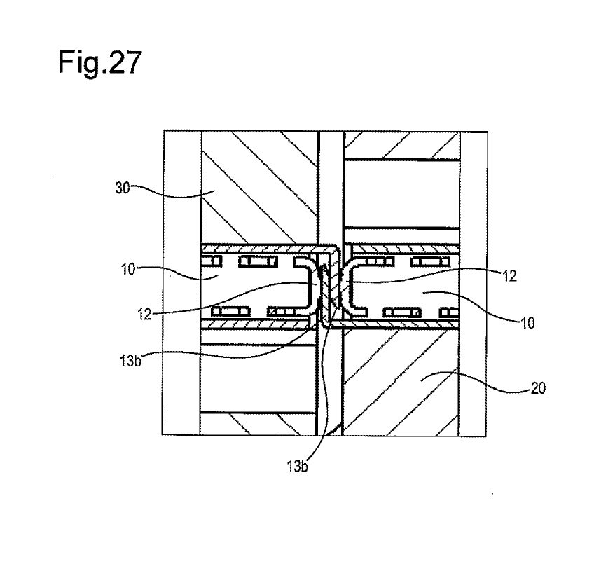

Also, FIG. 22(a) is a rear view showing a state immediately before the sliding operation of a pair of connector housings in the second embodiment is completed, and FIG. 22(b) is a pertinent cross sectional view showing the mutual positional relation of the butted terminals in the fitted state in FIG. 22(a), FIG. 23 is a longitudinal sectional view showing the mutual positional relation of the butted terminals in the fitted state of a pair of connector housings shown in FIGS. 22(a) and 22(b), FIG. 24 is an enlarged view of an N part in FIG. 23, FIG. 25(a) is a rear view showing a state that the fitting connection of a pair of connector housings in the second embodiment is completed, and FIG. 25(b) is a pertinent cross sectional view showing the mutual positional relation of the butted terminals in the fitting completed state in FIG. 25(a), FIG. 26 is a longitudinal sectional view showing the mutually butting state of the butted terminals in a state that the fitting connection between a pair of connector housings in the second embodiment is completed, and FIG. 27 is an enlarged view of a P part in FIG. 26.

In a butted connector 1A of the second embodiment shown in FIG. 18 to FIG. 27, the reference symbols common to those in the first embodiment are affixed to the configurations that are common to those of the butted connector 1 in the first embodiment, or the configurations that correspond to those of the butted connector 1 in the first embodiment, and explanation of such configurations will be simplified hereunder.

In the case of the butted connector 1A of the second embodiment, as shown in FIG. 18, one connector housing 30 out of a pair of connector housings 20, 30, which are to be fitted and connected, has a profile shaped like a substantially rectangular parallelepiped. A lock projection 37 is provided on both side surfaces of the connector housing 30 respectively to protrude outward. These lock projections 37 are engaged with the connector housing 20 when the fitting connection of the connector housing 30 to the connector housing 20 is completed.

Also, in the other connector housing 20 to which the connector housing 30 is fitted and connected, the hood portion 25 extended on the top end side provides a containing space 26 shaped like a substantially rectangular parallelepiped, to which the connector housing 30 is fitted and installed. The containing space 26 corresponds to the space whose upper side that intersects orthogonally with the housing central axis C1 of the connector housing 20 is opened.

Also, a lock hole 27 is provided in both side walls of the hood portion 25, which defines the containing space 26, respectively. The lock projection 37 is engaged with the lock projections 37 respectively when the fitting connection of the connector housing 30 to the connector housing 20 is completed.

The second embodiment is common to the first embodiment in that the butted terminals 10 shown in FIG. 3 and FIG. 4 are installed into the terminal containing holes 21, 31 provided in the connector housings 20, 30 respectively.

In the case of the butted connector 1A of the second embodiment, respective slide starting positions PS set on a pair of connector housings 20, 30 are placed in the positions where the housing central axes C1, C2 of respective connector housings are displaced in the direction, which intersects orthogonally with the housing central axes C1, C2 (an arrow Y2 direction in FIG. 18), respectively.

Concretely, the slide starting position PS corresponds to the upper end edge of the containing space 26, as shown in FIG. 20(b), in the direction that intersects orthogonally with the housing central axes C1, C2, and also corresponds to the position where the top ends of respective housings come in touch with each other, as shown in FIG. 23, in the axial direction of the housing central axes C1, C2.

Also, the sliding operation taken when a pair of connector housings 20, 30 are fitted and connected mutually corresponds to the translating operation in the direction that intersects orthogonally with the housing central axes C1, C2, as indicated with an arrow Y3 in FIG. 20 (a).

When the sliding operation for pushing the connector housing 30 into the containing space 26 is executed from the slide starting position PS shown in FIG. 20, the mutual fitting of the connector housings becomes deeper, as shown in FIG. 21 and FIG. 22, with the progress of the sliding operation.

In the sliding operation executed from the slide starting positions PS of the mutual housings, as shown in FIG. 23 and FIG. 24, the axial positions of respective butted terminals 10 are placed such that the positioning piece portions 13b formed at the top ends of the butted terminals 10, which are installed into the connector housings 20, 30 respectively, can be engaged with each other by the sliding operation.

As shown in FIGS. 25 (a) and (b), a lower face 30a of the connector housing 30 comes in touch with an inner bottom face 25b of the hood portion 25 at the termination of the sliding operation, so that the further pushing operation of the connector housing 30 is restricted. At this time, not only the positions of the terminal containing holes 21, 31 arranged in the connector housings 20, 30 are aligned with each other respectively, but also the lock projections 37 on both sides of the connector housing 30 are engaged with the lock holes 27 of the connector housing 20 respectively, as shown in FIG. 25(b). Thus, the mutually connected state of the connector housings is locked.

In the case of the butted connector 1A of the second embodiment, as shown in FIG. 26 and FIG. 27, the butted terminals 10 installed into respective housings are put in their butted state in the state that the fitting connection of the connector housings 20, 30 is completed. In their butted state, the positioning piece portions 13b at the top ends of the butted terminals 10 are forced to break into places between the positioning piece portions 13b and the butted plate portions 12 of the counter butted terminals 10 correspondingly.

In the case of the butted connector 1A of the second embodiment explained above, not only the mutual connection of the connector housings but also the mutual connection of the butted terminals 10 can be completed, by simply translating respective connector housings in the direction that intersects orthogonally with the housing central axes C1, C2 after a pair of connector housings 20, are placed in the slide starting position PS respectively. As a result, the operability needed in connecting the butted terminals 10 mutually can be improved.

### Third Embodiment

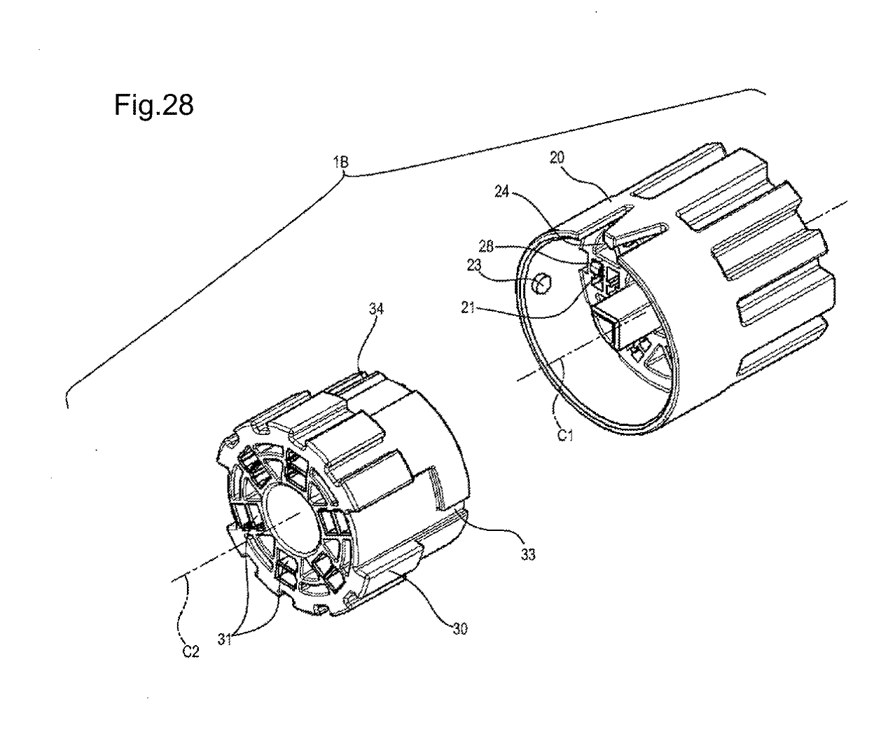

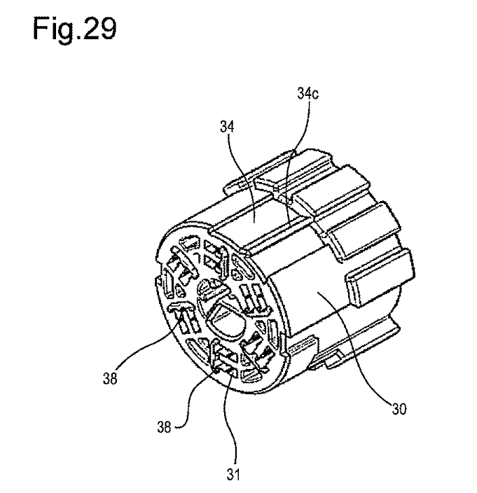

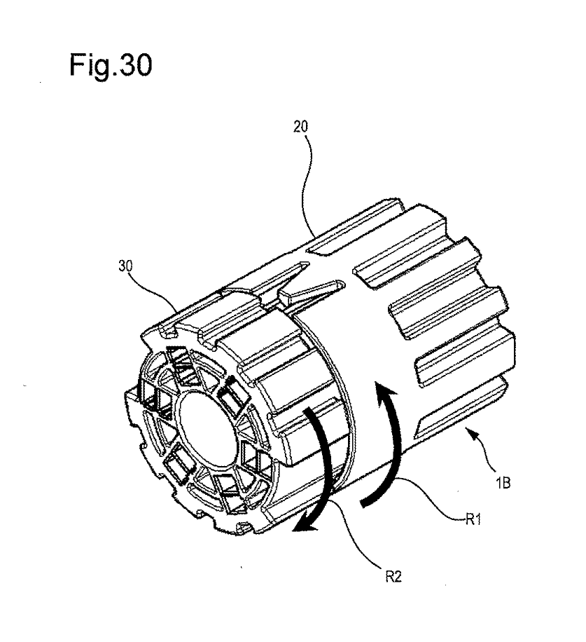

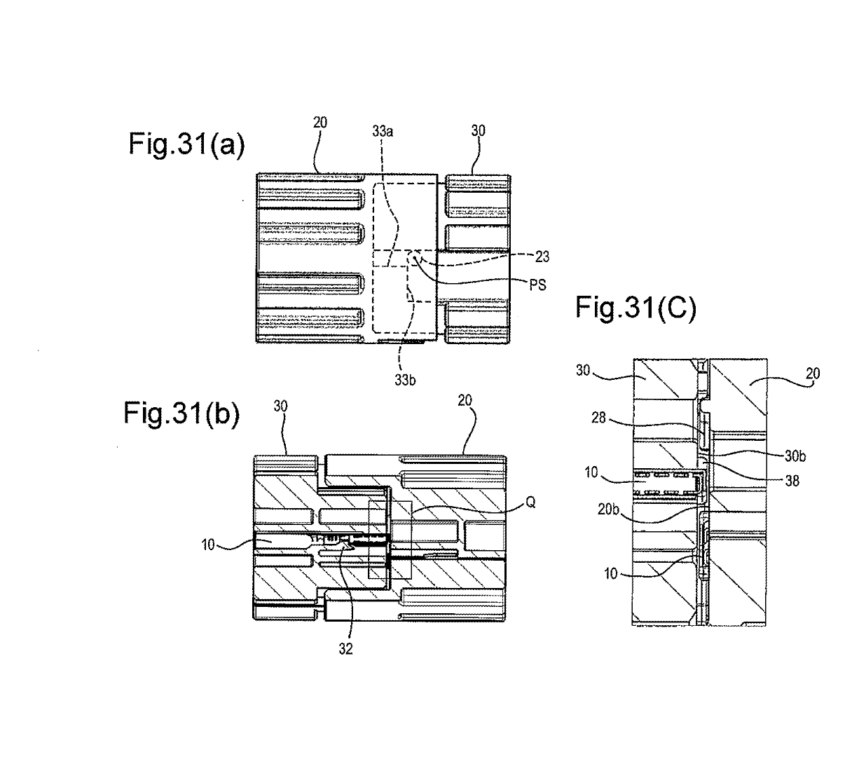

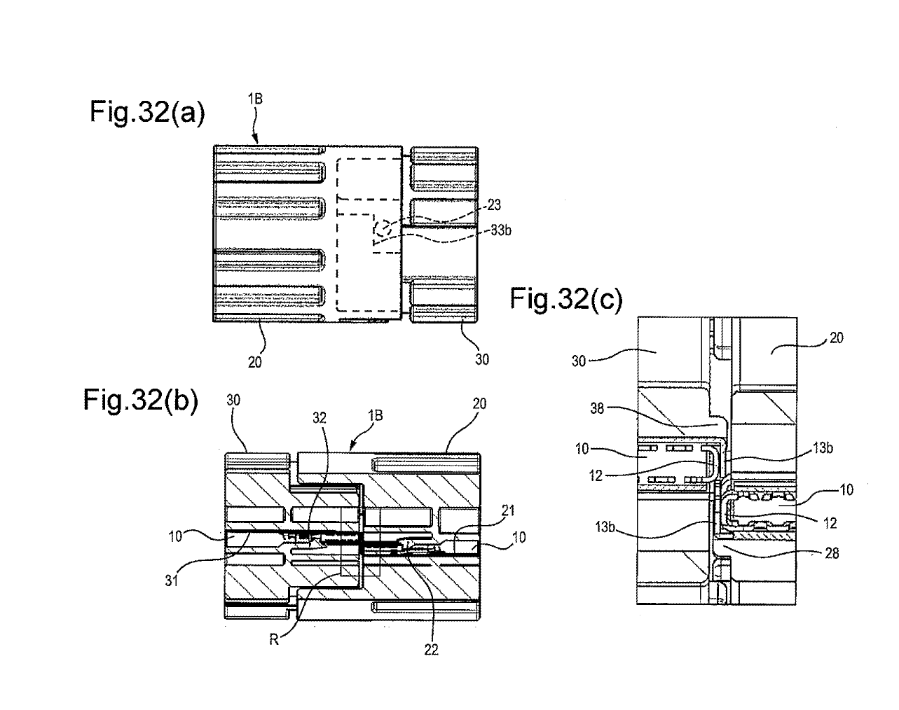

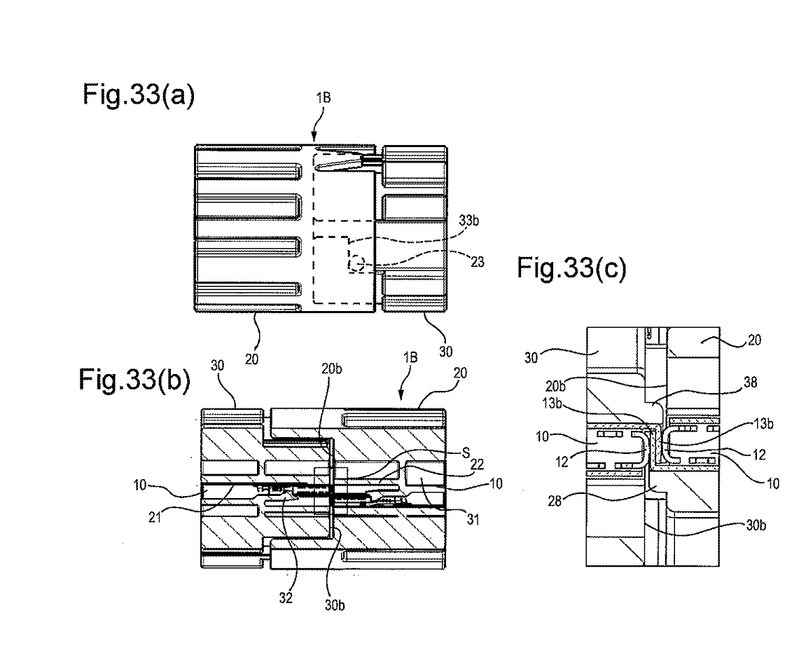

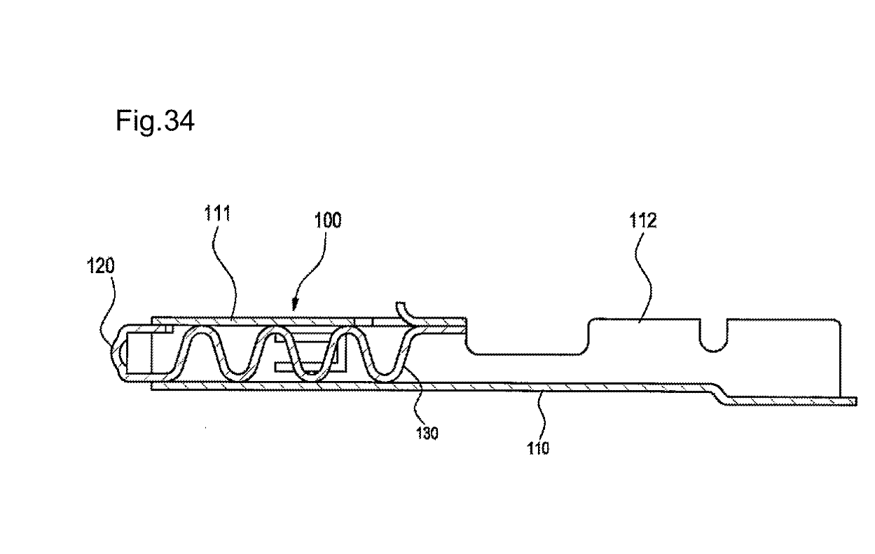

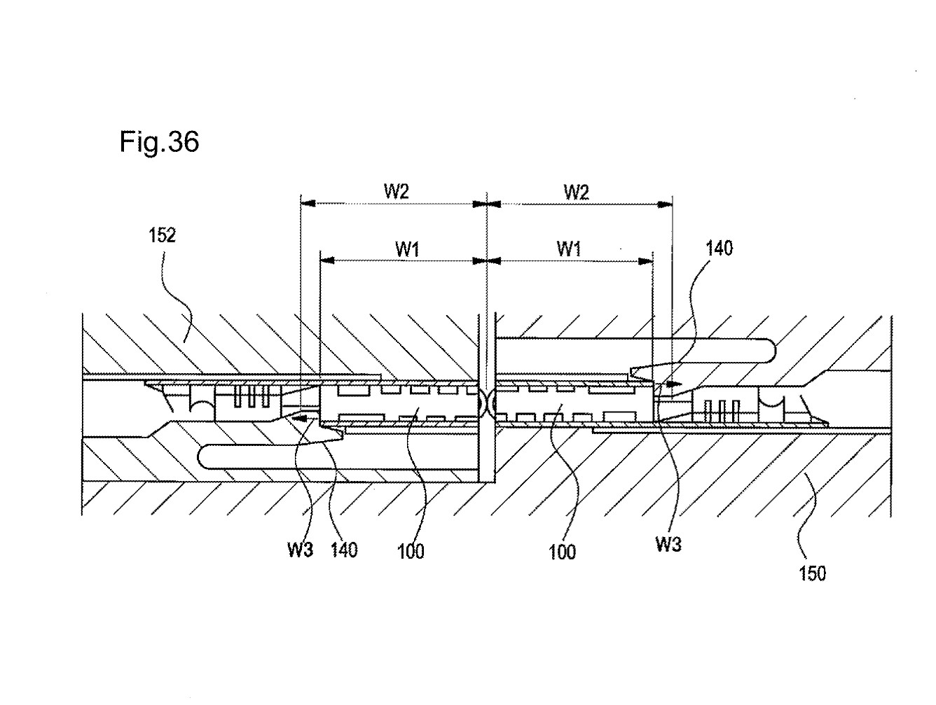

FIG. 28 to FIG. 33(c) show a configuration of a third embodiment of a butted connector according to the present invention. Here, FIG. 28 is an exploded perspective view of the third embodiment of the butted connector according to the present invention, FIG. 29 is a perspective view showing one of the connector housings shown in FIG. 28 when viewed from the top end side, FIG. 30 is a perspective view showing an intermediate state that a pair of connector housings shown in FIG. 28 are being fitted, FIG. 31(a) is a side view showing a state that a pair of connector housings in the third embodiment are positioned in the slide starting position, FIG. 31(b) is a longitudinal sectional view showing the mutual positional relation of the butted terminals in the fitted state shown in FIG. 31(a), and FIG. 31(c) is an enlarged view of a Q part in FIG. 34(b), FIG. 32(a) is a side view showing an intermediate state that a pair of connector housings in the third embodiment are being operated to turn around a housing central axis from the slide starting position, FIG. 32(b) is a longitudinal sectional view showing the mutual positional relation of the butted terminals in the fitted state shown in FIG. 32(a), and FIG. 32(c) is an enlarged view of an R part in FIG. 32(b), and FIG. 33(a) is a side view showing a state that the fitting connection of a pair of connector housings in the third embodiment is completed, FIG. 33(b) is a longitudinal sectional view showing the mutual positional relation of the butted terminals in the fitted state shown in FIG. 36(a), and FIG. 33(c) is an enlarged view of an S part in FIG. 36(b).

A butted connector 1B of this third embodiment corresponds to such a connector that a part of the butted connector 1 of the first embodiment is improved.

The improved point resides in that, as shown in FIG. 28 and FIG. 29, terminal protection projections 28, 38 are provided to the top end portions of a pair of connector housings 20, 30 respectively.

As shown in FIG. 31, the terminal protection projections 28, 38 come in contact with butted faces (top end faces) 20b, 30b of the counter connector housings at the time when the connector housings are placed in the slide starting position PS respectively. Also, the terminal protecting projections 28, 38 are slid over the butted faces 20b, 30b of the counter connector housings at a time of the sliding operation, and restrict the displacement of the mutual connector housings in the direction of the housing central axes C1, C2.

The butted connector 1B of the third embodiment has the configurations common to those of the first embodiment except that the terminal protecting projections 28, 38 are added. The same reference symbols are affixed to the common configurations, and their explanation will be omitted herein.

In the case of the butted connector 1B of the third embodiment explained as above, when a pair of connector housings 20, 30 are fitted and connected mutually, the connector housings are relatively turned from the slide starting positions PS mutually, as shown in FIG. 30 and FIG. 31, and then the positions of the terminal containing holes 21, 31 being displaced in the circumferential directions of respective housings are aligned with each other, as shown in FIG. 32 (a) to FIG. 33(c). Consequently, the butted terminals 10 of respective connector housings can be butt-connected. In this manner, a clearance between the mutual top end portions of the butted connector housings can be maintained by the terminal protection projections 28, 38, which are provided to the top end portions of the connector housings respectively, during the sliding operation by which the mutual connector housings are turned relatively from the slide starting positions PS. As a result, when a protruded length of the terminal protection projections 28, 38 is selected adequately in advance, it can be avoided that an excessive impact force would be applied to the butted terminals 10 at a time of the butting operation, and also it can be prevented that the butted terminals 10 would be deformed by the impact applied in the butting operation.

In this case, the butted connector of the present invention is not restricted to respective embodiments mentioned above, and appropriate variations, improvements, and the like can be applied.

According to the butted connector of the present invention, the butted connection of the butted terminals at the time when the fitting connection of a pair of connector housings is completed corresponds to the sliding operation by which the top ends of the butted terminals are caused to engage with each other. Therefore, a large impact force does not act to the butted terminals in the axial direction. Further, the mutual engagement of the top-end positioning pieces can restrict the disengagement of the butted terminals, which have already been held in the butted state, from the counter butted terminals in the axial direction, and also can suppress such an event that the axial load is applied to the lances respectively.

As a result, it can be suppressed that a resin creep would be generated in the lances, and the like of respective connector housings. Also, it can be prevented that a contact pressure applied between the butted terminals would be decreased by the resin creep of the lances, and the like.

Also, the top ends of the butted terminals are engaged with each other at the time when the butted terminals installed in respective connector housings are caused to butt into each other. Therefore, the foreign substances such as the oxide films, the dusts, or the like, which adhere onto the surfaces of the butted plate portions of the butted terminals, can be scrubbed off in the preceding stage to the butting operation. As a result, such a situation is never caused that the foreign substances adhere between the butted terminals that are to be butted into mutually and thus the mutual conductive connection between the butted terminals is spoiled.

Accordingly, mutual connectivity of the butted terminals can be maintained satisfactorily for a long term.

What is claimed is:

1. A butted connector, comprising:
a butted terminal to a top end of which a butted plate portion that comes into a conductive state to a counter terminal when the butted terminal is brought into contact with the counter terminal is provided; and
a pair of connector housings which have a terminal containing hole into which the butted terminal is inserted, and a lance that latches the butted terminal, which is already inserted into the terminal containing hole, in a normal position where the butted plate portion is set to protrude ahead of the terminal containing hole by a predetermined length, respectively, and which are fitted and connected mutually;
wherein mutual connection of the connector housings is completed when mutual positions of terminal containing holes in the connector housings are aligned with each other by displacing respective positions of the terminal containing holes on mutual top end faces in a direction that intersects orthogonally with the housing central axes, and executing a sliding operation of the pair of connector housings in the direction that intersects orthogonally with the direction along the housing central axes from slide starting positions, in which the connector housings are opposed to each other at a predetermined clearance in a direction along the housing central axes, whereby the sliding operation enables mutual top ends of the butted terminals, which are already installed into respective connector housings, to engage with each other and also enables the mutual top ends of the corresponding butted terminals to bring into their butted state, and
the butted terminal has a top-end positioning piece that is engaged with the counter butted terminal to restrict a disengagement from the counter butted terminal in an axial direction when a top end of the butted terminal is forced to engage with the counter butted terminal.

2. The butted connector according to claim 1, wherein the slide starting positions on the pair of connector housings correspond to positions in which the connector housings are displaced in phase around the housing central axes by a predetermined angle respectively in such a condition that the housing central axes of respective connector housings are aligned with each other, and
the sliding operation corresponds to a turning operation executed around the housing central axes respectively.

3. The butted connector according to claim 1, wherein the slide starting positions on the pair of connector housings correspond to positions in which the housing central axes of respective connector housings are displaced in the direction that intersects orthogonally with the housing central axes, and
the sliding operation corresponds to a translating operation executed in the direction that intersects orthogonally with the housing central axes.

4. A butted connector according to claim 1, wherein a terminal protection projection, which comes in touch with a counter connector housing when the connector housings are positioned in the slide starting positions respectively and also slides on a butted face of the counter connector housing at a time of the sliding operation to restrict a displacement of mutual connector housings in the direction along the housing central axes, is provided to top end portions of the pair of connector housings respectively.
